(19) United States
(12) Patent Application Publication
(10) Pub. No.: US 2006/0037176 A1
(43) Pub. Date: Feb. 23, 2006

(54) Kitchen implement and handle

(75) Inventors: Carter W. McGuyer, Muscle Shoals, AL (US); Rodney W. Robbins, Florence, AL (US)

Correspondence Address: Gregor N. Neff, Esq.;Kramer Levin Naftalis & Frankel LLP, 1177 Avenue of the Americas, New York, NY, 10036, US

(73) Assignee: Robbins Industries, Inc.

(21) Appl. No.: 11/247,903

(22) Filed: Oct. 10, 2005

Related U.S. Application Data
(63) Continuation-in-part of application No. 11/081,300, filed on Mar. 16, 2005.
Application No. 11/081,300 is a continuation-in-part of application No. 10/177,699, filed on Jun. 20, 2002.

(51) Int. Cl. B25G 1/10

(52) U.S. Cl. 16/430

(57) ABSTRACT

The handle is ergonomically shaped. It is given a wasp-like shape, with a flexible cover. The handle is used both as a fixed, permanent handle for a single kitchen implement, and as a handle for receiving and holding interchangeable kitchen implements. In one preferred embodiment, the handle has a fluid silicone gel layer underneath an outer-cover to better conform the shape of the handle to the user's hand.

This invention relates to kitchen utensils, kitchen utensil kits and manufacturing methods. This is a continuation-in-part of U.S. patent application Ser. No. 10/177,699, filed Jun. 20, 2002, and of U.S. patent application Ser. No.: 11/081;300 filed Mar. 16, 2005.

The crowding and jumble of kitchen utensils or implements in the usual kitchen drawer is a hindrance of long standing. The jumble makes it difficult to find individual implements, and often extends the time and exasperation in obtaining a utensil from the drawer due to the fact that the drawer cannot be closed until the utensils in the drawer are rearranged.

One of the causes of the foregoing problems is the amount of space occupied by each implement.

Proposals have been made in the past to provide a partial solution to this problem by supplying a single handle with a plurality of attachments to be attached to the handle, each being an implement for a different purpose.

Such prior proposals have been considerably less than fully satisfactory. Although, in theory, those proposals result in a reduction of the volume occupied by the kitchen utensils, they are believed to do little to lessen the jumble and difficulty of finding and retrieving specific implements.

Furthermore, the means used to attach the individual accessories to the handle are relatively difficult to use and/or less than fully satisfactory in other ways.

Another problem with some kitchen implements, especially those whose handles are visible when the implements are stored, such as kitchen knives, is that the handles are not dishwasher-safe; that is, the handles, usually made of wood or heat-sensitive plastics, will fade, crack or otherwise deteriorate if they are washed frequently in the dishwasher. Furthermore, the cost of providing an individual handle for each of several utensils can be substantial.

Accordingly, it is an object of the present invention to provide a kitchen utensil device which alleviates or resolves the above problems.

In particular, it is an object to provide a utensil system in which the cost and space required by providing handles for each of several utensils is significantly reduced, and in which the system components are ordered and housed so as to minimize tangling and disorder of the components, and to minimize the use of kitchen drawer and other storage space.

It is another object of the invention to provide a multi-tool kitchen implement device with a handle and a plurality of attachments easily and securely attachable to and detachable from the handle.

It is a further object of the invention to provide such a multi-tool device which is relatively strong, durable, simple in construction and easy to use and store.

Another object of the invention is to provide kitchen implement multi-tool devices with a handle which is ergonomically shaped and structured so as to make it easy to grasp and comfortable to use.

It is a further object of the invention to provide a method of manufacturing the multi-tool device of the invention and the kit with economy, speed and quality.

An additional object is to provide a multi-tool kitchen device and kit in which the tools are both attractive in appearance and yet are made dishwasher-safe at a moderate to low cost.

In accordance with the present invention, the foregoing objectives are satisfied by the provision of a multi-tool kitchen utensil kit with a container to hold and organize a plurality of components of a multi-tool device in the container.

Preferably, the container has a plurality of recesses, each shaped to hold a component of the multi-tool device. Each kit is adapted to be secured together with other containers containing different components of the multi-tool device to form a organization system to keep the tool components in an orderly fashion in a kitchen drawer or on a shelf, or in another available space.

In one embodiment, each recess is shaped to receive a specific component, and means are provided for attaching various containers together to form a unitary support structure for holding and organizing the multi-tool components neatly in a kitchen drawer. Thus, space is saved and the usual jumble of kitchen implements in the drawer is avoided.

Alternatively, the kit includes a container for storage on a counter-top or similar surface.

The implements can be stored with one end up in a relatively deep container, or flat in a relatively shallow container for use in shallow drawers.

The single handle needed for use with a variety of tools, and the tools themselves, are both dishwasher-safe and attractive in appearance, without being unduly costly to make.

In one embodiment of the kit, the handle and a plurality of accessories are stored in units suitable for display on a kitchen counter-top, shelf or other such surface. The kit does double-duty in that it is useful for display of the product in stores, on television and in other advertising.

The multi-tool device includes a handle with attachment means connectable with mating attachment means on each of a plurality of accessories. Advantageously, each accessory can simply be inserted and snapped into place and held securely in the handle. The accessory then can be detached by the simple act of pushing or pulling one or two buttons or levers and allowing gravity to remove the accessory.

The handle advantageously is ergonomically shaped, and is manufactured by co-molding a flexible elastomeric cover over a molded plastic handle to provide a handle which can be firmly, easily and comfortably gripped while wielding the kitchen implement attached to it.

The handle shape and structure is highly advantageous for use in permanently attached handles, as well as in multi-tool handles.

In another embodiment of the handle, a layer of silicone gel is positioned under an outer silicone rubber coating to provide a handle for either multi-tool sets or kitchen implements with permanently attached handles which conform closely to the shape of the hand of the user for greater comfort and better gripping of the handle.

The foregoing and other objects and advantages of the invention will be described in or apparent from the following description of the drawings.

### IN THE DRAWINGS

FIG. 1 is a perspective view of a multi-tool kitchen utensil kit of the present invention;

FIG. 2 is a cross-sectional, broken away view illustrating the attachment of the two kit modules of FIG. 1 together;

FIG. 3 is a top plan view of a kitchen drawer with various kit modules located in the drawer to organize and arrange the components of a multi-tool kitchen utensil or implement system;

FIG. 4 is a perspective view of a preferred embodiment of the handle of the multi-tool device of the present invention;

FIG. 5 is an exploded perspective view of the handle shown in FIG. 4;

FIG. 6 is a phantom side elevation view of the handle shown in FIG. 4;

FIG. 7 is a schematic cross-sectional view taken along lines 7-7 of FIG. 4;

FIGS. 8 and 9 are front elevation views showing the handle of FIG. 4 in two different operative configurations;

FIG. 10 is a perspective view of a component of the handle shown in FIG. 4;

FIG. 11 is a broken-away perspective view of another component of the handle of FIG. 4;

FIG. 11A is a cross-sectional view of another embodiment of the implement handle of the invention;

FIG. 11B is a schematic view of the handle of FIG. 11A in use;

FIG. 11C is a top plan view of a preferred soft-grip kitchen implement handle of the invention;

FIG. 11D is a cross-sectional view taken along line 11D-11D of FIG. 11C;

FIG. 11E is a perspective view of the core member of the handle of FIGS. 11C and 11D;

FIG. 11F is a top plan view of the core member shown in FIG. 11E.

FIG. 12 is a perspective view of a pizza cutter accessory for the handle down in FIG. 3;

FIGS. 13 and 14 are perspective views showing the process of attachment of the pizza cutter of FIG. 12 to the handle of FIG. 4;

FIG. 15 is a perspective view of a cheese slicer accessory;

FIG. 16 is a perspective view of a citrus peel scraper or “zester” accessory;

FIG. 17 is an exploded view of the device shown in FIG. 16;

FIG. 18 is a perspective view of a citrus fruit reamer accessory;

FIG. 19 is a perspective view of an ice cream scoop accessory;

FIG. 20 is a perspective view of a “horizontal” accessory peeler accessory;

FIG. 21 is a perspective view of a melon baller accessory;

FIG. 22 is an exploded view of a “straight” peeler accessory;

FIG. 23 is a perspective assembly view of the device shown in FIG. 22;

FIG. 24 is a perspective view of another embodiment of the invention;

FIG. 25 is an exploded perspective view of the device shown in FIG. 24;

FIG. 26 is a cross-sectional, partially schematic broken-away view taken along line 26-26 of FIG. 24;

FIG. 27 is a top plan view, partially cross-sectional and partially schematic, of the device shown in FIGS. 24 through 26;

FIG. 28 is a perspective view of another embodiment of the invention with a zester accessory;

FIG. 29 is an exploded view of the device shown in FIG. 28, with a straight peeler accessory;

FIG. 30 is an exploded perspective view of the device of FIG. 28 with an ice cream scoop accessory;

FIGS. 31 and 32 are top plan views, partially schematic, and partially cross-sectional, of two additional embodiments of the invention;

Each of FIGS. 33 through 39 is a top plan view of a different accessory for use with the handle of the invention;

FIG. 40 is a side elevation view of a component holder and kit provided in accordance with the present invention;

FIG. 41 is a cross-sectional view of another comment holder and kit provided in accordance with the invention;

FIG. 42 is a perspective, partially exploded view of another component holder and kit provided in accordance with the present invention;

FIG. 43 is a rear elevation view of each of the modules shown in FIG. 42; and

FIG. 44 is a perspective view of a grater accessory provided in accordance with the present invention.

### MULTI-TOOL KITCHEN UTENSIL KIT

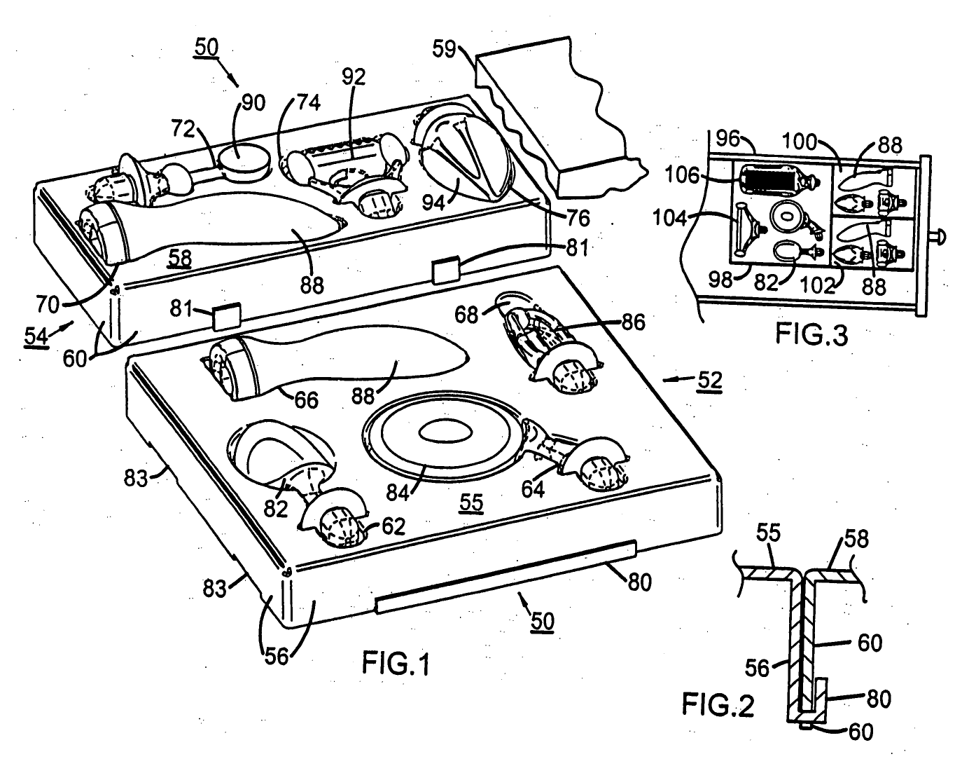

FIGS. 1-3 illustrate one embodiment of the multi-tool kitchen utensil or implement kit 50 constructed in accordance with the present invention.

The kit 50 includes at least one container 52 containing a plurality of components for interconnection to one another to form various kitchen tools. Two such containers 52 and 54 are shown in FIG. 1 to illustrate the different forms that the containers and their contents can take.

The container 52 is generally rectangular in shape, and has four vertical side walls 56 and a top wall 55. The top wall 55 has a plurality of depressions 62, 64, 66 and 68, each of which is shaped to receive a specific component of a multi-tool device.

The components to be used in a particular grouping can be varied as desired. However, the grouping shown in container 52 includes a handle 88, an ice cream scoop 82, a pizza-cutting wheel 84 and a peeler 86.

Container 54 also has four vertical side walls 60 and an upper wall 58. It is smaller in size than the container 52, and contains different components of the multi-tool system. The upper wall 58 has recesses 70, 72, 74 and 76 in which are located, respectively, a handle 88, a melon baller 90, a citrus fruit skin scraper or “zester” 92, and a citrus reamer or juicer 94.

A cover 59 is shown for the container 54, which would cover the container when sold in stores. A similar cover normally will be provided for the container 52.

Each of the containers 52 and 54 is preferably molded of a thermoplastic resin such as ABS. Its walls are thick and sturdy enough to serve not only as packaging in which the product is shipped and sold, but to serve as durable storage and organizing means for the multi-tool components in the kitchen.

To this end, the container 52 is provided with an elongated upstanding tab 80 on the lower edge of at least one side wall.

FIG. 2 is a cross-sectional view showing the attachment of the two containers 52 and 54 together by use of the tab 80. The lower edge of the rear side-wall 60 of container 54 (not visible in FIG. 1) has a shallow notch , slightly longer than the tab 80. The front wall of the unit 54 is inserted into the clip formed by tab 80, so as to secure the containers together to form an enlarged container and organizer structure.

The container 54 has two separate tabs 81 which can be used to join the units 52 and 54 side-by-side, with the tabs 81 fitting into notches 83 in the side walls of the unit 52.

The notches in the lower edges of the rear and side walls are provided in order to accommodate the material of the tabs 80, 81 to ensure the bottom and top edges of the containers are aligned with one another.

FIG. 3 is a schematic top plan view of a kitchen drawer 96 containing several containers 98, 100 and 102 fastened together by clips formed by tabs 80 or 81 to occupy a portion of the drawer and provide organization and storage for a variety of components of the multi-tool system.

As an example, the container 98 is larger than the containers 100 and 102. It contains accessories for the multi-tool system, but no handles. Instead, it includes an ice cream scoop 82, a cheese slicer 104, a pizza-cutting wheel 84 and a grater 106.

Each of the containers 100 and 102 contains a handle 88 together with other accessories to be attached to the handles.

These containers and their arrangement in the kitchen drawer 96 are strictly by way of example to show just some of the combinations that can be used advantageously to store and organize the components of the multi-tool system neatly and compactly. Other kits constructed in accordance with the present invention are shown in other figures of the drawings and are described below.

### Handle

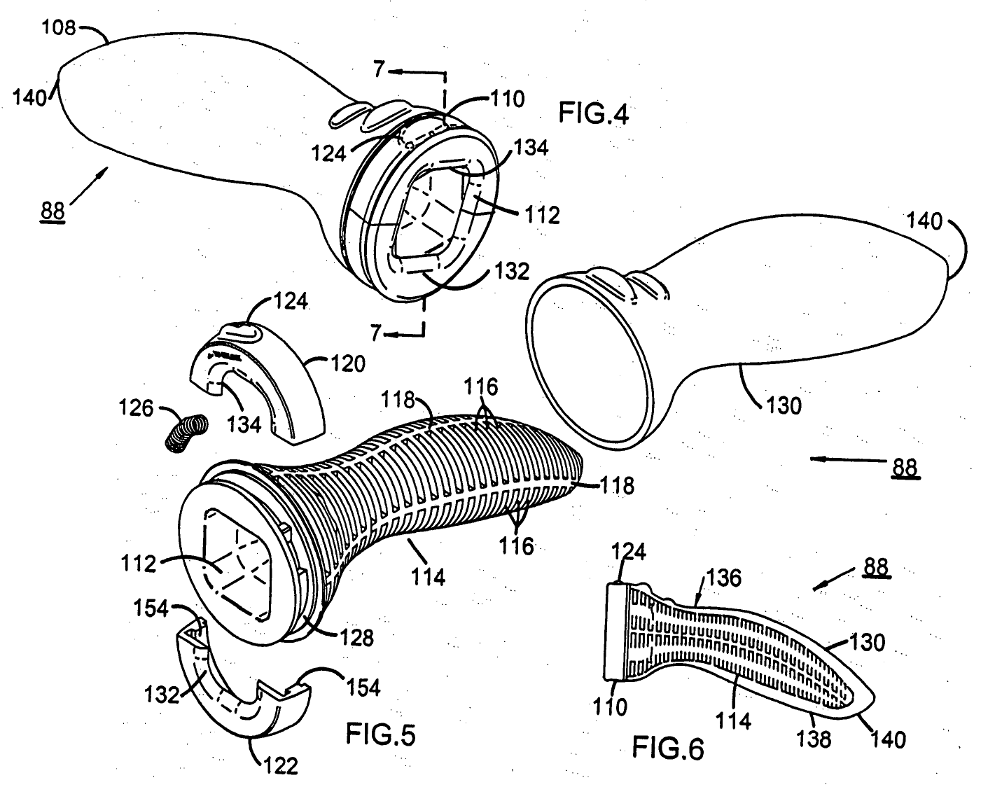

FIGS. 4 through 11 illustrate the preferred handle 88 of the multi-tool system.

The handle 88 has a hand grip portion 108 with a tapered shape and a pointed end 140. At the opposite end there is a rotatable locking ring 110 and a receptacle 112 for receiving a mounting projection on an accessory. The locking ring 110 operates in a snap-acting manner to lock an accessory in place and attach it to the handle by the simple step of inserting a projection into the receptacle 112. The attaching structure also allows the accessory to be detached easily, with one finger, merely by turning the locking ring 110 through a relatively small angle to free the accessory and allow it to fall out of the receptacle under the force of gravity, with the use of only one hand.

Referring now to FIG. 5, which is an exploded view of the handle 88, the handle has a hard molded plastic base 114. In one embodiment, the base 114 has a plurality of circumferential ribs 116 and longitudinal ribs 118. Preferably, the ribs 116 and 118 are of approximately the same thickness. The ribbed construction reduces the use of material and increases the molding speed with which the handles can be manufactured.

In accordance with another aspect of the invention, the handle also includes an elastomeric cover 130 which is co-molded in place over the base 114 during manufacturing.

The material of which the base 114 is made preferably is a very strong thermoplastic resin such as a polycarbonate material, and the cover 130 is made of an elastomeric material such as Sanoprene.

Although the ribbed construction for the base 114 saves polycarbonate material and some molding time, the spaces between ribs are filled with elastomeric material during co-molding of the cover 130. Because the elastomeric material can be considerably more costly than polycarbonate material, it is preferred to make the base member solid with a rough surface to which the elastomeric material adheres.

Surrounding the receptacle 112 is a circumferential groove 128 in which the latching ring 110 is seated for rotation.

The latching ring 110 preferably includes two halves 120 and 122, which are assembled and sonically welded together while an inner ring 154 is seated in the groove 128 and after a coil spring 126 has been inserted into the groove. The leading edges 132 and 134 of the two halves of the locking ring are rounded so as to give a rounded outside edge to help guide projections into the square opening formed by joining the ring halves 102 and 122. The inside edge of the ring around the central opening is flat. A protrusion 124 extends outwardly from the upper ring half 120 for use in rotating the ring 110.

As it is shown in FIG. 6, in which the base 114 is shown in dashed outline, the elastomeric cover 130 is of varying thickness along the length of the handle. It is relatively thin in a necked-down region 136 and is thicker towards the larger trailing end of the handle, thus providing extra softness in the areas to be gripped with the most pressure by the hand. This extra cushioning makes the handle easier and more comfortable to use.

The handle also is given a wasp-like cross-sectional shape, as also is apparent in FIG. 6, and is curved downwardly, also so as to conform to the shape of the hand holding the handle. However, this shape also is provided for decorative effect, and gives the handle a sleek, streamlined and attractive look.

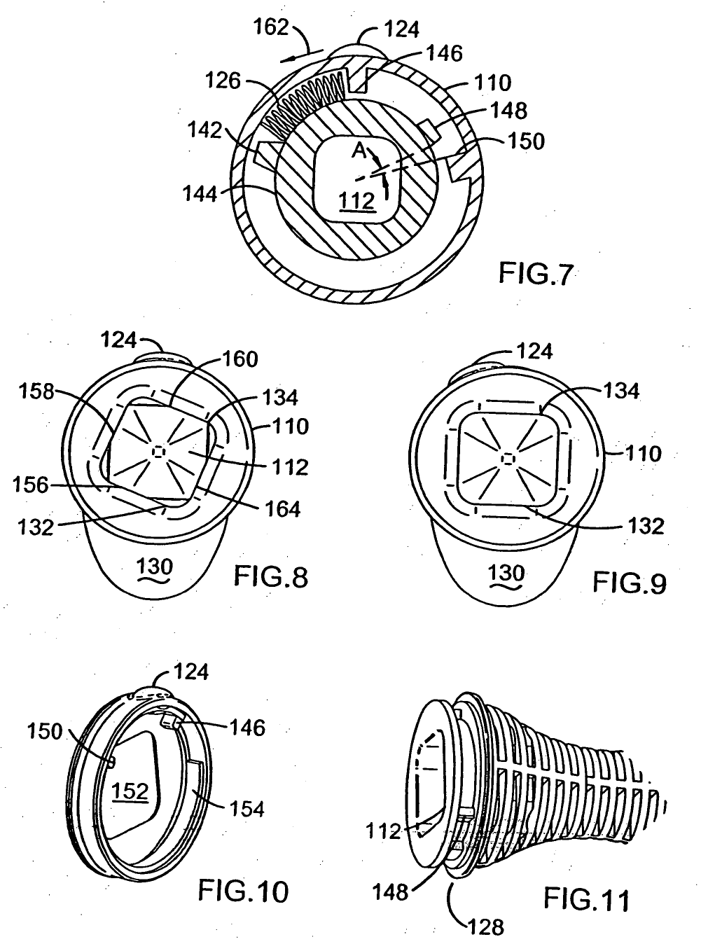

FIG. 7 is a cross-sectional schematic view showing the locking ring 110, the spring 126 which is used in the operation of the locking ring, and the inner construction of the attachment mechanism.

The handle has a body end portion 144 in which the rectangular-shaped recess 112 is formed. A first stop member 142 is attached to the body 144 member, and a second stop member 146 is attached to the internal surface of the ring 110.

A second stop member 148 extends from the body 144, and another stop member 150 extends from the inner surface of the ring 110. With the components in the rest position shown in FIG. 7, the stop members 148 and 150 are separated by an angle A of approximately 21°.

The operation of the locking ring will be explained below after the following description of the locking structure on the accessories.

### Soft-Grip Handle

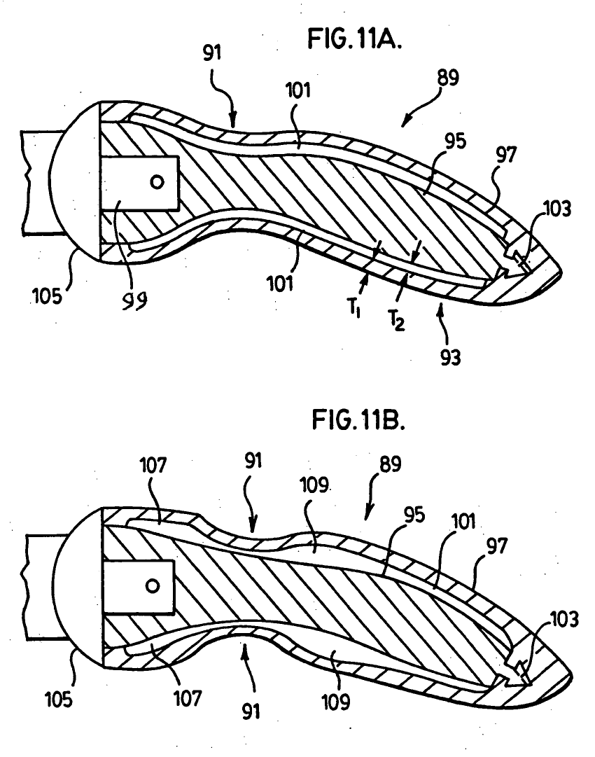

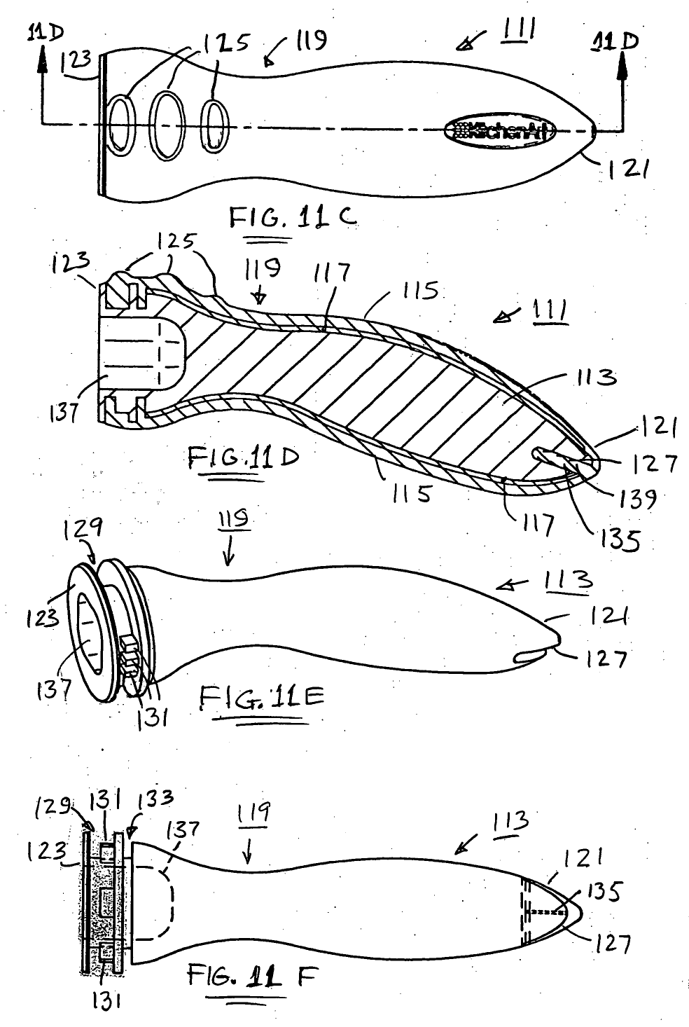

FIG. 11A is a cross-sectional view like FIG. 6 of another handle structure 89 of the present invention.

The handle 89 can be used with the latching structure described above and shown in FIGS. 4-11 to receive, latch and unlatch kitchen implements. However, the handle 89, as well as the handle 88 preferably is used as a handle permanently fixed to a single implement indicated at 105.

The handle 89 has substantially the same shape as the handle 88. It has the “wasp” shape with a region 91 of smaller diameter, and an end portion 93 of larger diameter which curves downwardly.

In accordance with another feature of the invention, the handle 89 has a soft feel which conforms easily to the pressures applied by the hand of the user to make the handle more comfortable to grasp and hold, especially if the user has arthritis or stiffness of the hands.

The handle 89 comprises a hard molded ABS or other suitable hard core 95, an outer layer 97 of flexible solid silicone rubber, and an intermediate layer 101 of silicone gel.

The kitchen implement 105 is secured to the handle 89 by embedding a projection 99 in the material of the inner core 95, either by co-molding or epoxy resin.

The lower right-end 103 of the handle core 95 has a Christmas-tree shape, which gives ample surface area to contact the material of the outer layer 97 to hold the two parts together firmly.

The gel layer 101 is approximately one-half the thickness of the outer layer 97. For example, the outer layer in one unit actually built and successfully tested had a thickness T₁ of approximately 0.20 inch, and the gel layer 101 had a thickness T₂ of about 0.10 inch.

The gel is one of a group of fluid siloxane polymers suitable for the purpose and readily available from a number of suppliers. The gel preferably has an intermediate viscosity in the range of approximately 100 to 1,000 centistokes, corresponding to a molecular weight of about 10,000 to 30,000.

The outside cover is a solid silicone rubber with a hardness of about 50±2 Shore A.

Thus, when the user grips the handle 89, the flexible cover 97 transmits pressure from the gripping parts of the user's hand, the gel 101 becomes thinner in the area where pressure is applied and bulges outwardly elsewhere, and, due to its viscosity, holds the shape for some time, making the sometimes strenuous use of the implement more comfortable for the user.

After the user is finished, the gel will restore itself to its original shape, after a period of time. Then, the handle is ready to conform itself to the shape of a different hand of another user, or a different grip from the first user's hand.

The handles 88 and 89 are dishwasher safe.

FIG. 11B shows schematically an example of how the dimensions of the handle can change due to the use of the gel layer 101. The handle 89 has been squeezed hard by a user who has relatively small hands. The user squeezes in the area 91, the gel moves sideways in the handle, as shown in FIG. 11B, so that the handle bulges outwardly at 107 and 109, and the diameter of the handle at 91 has been reduced so that the user's hand can get a better grip.

FIG. 11C is a top plan view of a preferred handle of the invention. The handle 111 is essentially the same as the handle show in FIGS. 11A and 11B, but with some improvements.

The handle 111 includes a hard molded plastic core member 113, a silicone rubber cover 115, with a layer 117 of silicone gel between the cover and the core member.

The core member has a left end 123 and a right end 121 with an area 119 of reduced cross section and a downwardly-angled right-hand portion forming a wasp-like shape, as in the embodiments described above.

The cover 115 has 3 raised bumps 125 on the upper surface of the handle near the left end 123.

As it is shown most clearly in FIG. 11D and FIGS. 11E and F, a rounded rectangular socket hole 137 is provided to receive socket members from various implements. Preferably, the projections are secured into the sockets by means of epoxy or similar adhesive means.

FIGS. 11E and 11F show the core member 113 in detail. As it is seen in FIGS. 11E and 11F, near the left end 123 of the core member is a circumferential recess 129. Extending outwardly from the bottom wall of the recess are projections 131 extending laterally from both sides of the handle, as shown in FIG. 11F. Also, inwardly from the recess 129 is a thinner, or narrower, recess 133.

The material of the left-end portion of the cover 115 is shaped to fit into the recesses 129 and 133 so as to closely engage the projections 131 and fit into the recesses 129 and 133. This is highly desirable in that it holds the cover 115 against slippage longitudinally, and prevents the cover from rotating on the core member.

Similarly, at the right hand end 121 of the core member is a horizontal slot 127 which has reverse-sloping teeth or barbs 135.

As it is shown in FIG. 11D, a flat projection 139 fits into the slot 127 and is engaged by the barbs 135 to hold the cover material in the slot. This construction provides very strong resistance against the cover 115 being twisted and rotated on the core member 113.

Preferably, the core member 113 is molded from ABS or other suitable relatively hard plastic material, and the cover is molded of silicone rubber, with the physical characteristics described above for the handle shown in FIGS. 11A and 11B. The cover 115 is molded for fitted onto the core member 113, and the silicone gel is injected into the space between the cover and the core member. The gel has the same physical characteristics as the gel used in the FIGS. 1A and 1B embodiment.

The silicone rubber material of the cover fills the recesses 129 and 133 and the spaces between the projections 131 and enters the slot 127 to provide a firm, twist-resistant bond between the cover and the core member.

### Accessory Locking Structure

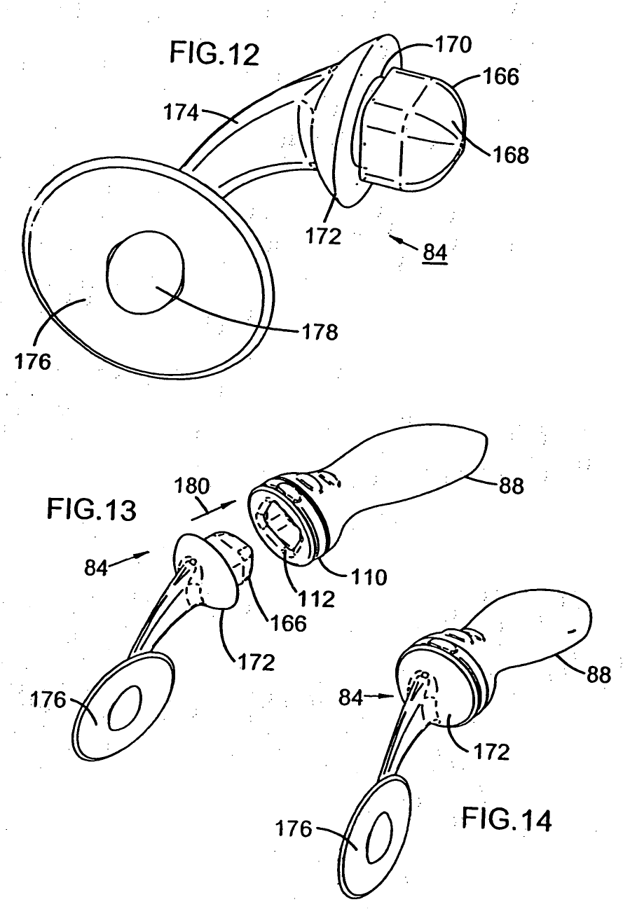

FIGS. 12 through 14 show the pizza-cutting wheel accessory 84 which is one of a number of accessories which can be attached to the handle 88.

FIG. 13 is an exploded view showing the insertion of the pizza wheel locking structure into the handle 88 in the direction indicated by arrow 80. FIG. 14 shows the pizza wheel and the handle assembled together and ready for use.

Referring particularly to FIG. 12, at one end of the pizza wheel 84 is a projection 166 with a square cross-section matching that of the receptacle 112 in the handle but with slightly smaller dimensions so that it fits into the receptacle 112 easily. The projection 166 has a rounded front end 168 for use as a camming surface.

A circumferential groove 170 extends around the projection 166 at its base. A flange 172 which is flared or rounded on its left surface and is of approximately the same outer diameter as the ring 110, is provided and forms one wall of the groove 170.

A molded plastic curved arm 174 extends from the flange 172 and a stainless steel cutting blade 176 is rotatably mounted on the end of the arm 174 by means of a fastener 178. Preferably, the arm 174 and the fastener 178 are molded plastic, as is the projection 166 and the other components of the pizza wheel, except for the cutting blade 176.

It should be understood that each of the accessories to be attached to the handle has a projection 166 and groove 170 and is attached to and detached from the handle in the same way as the pizza wheel. The pizza wheel is being used as a vehicle for explanation of the attachment function.

### Operation

Referring again to FIGS. 7 through 11, as well as FIGS. 12 through 14, the attachment of an accessory to the handle 88 will be described.

FIG. 8 shows the locking ring 110 in its relaxed or stable condition as shown in FIG. 7, in which the coil spring 126 holds the ring in the position shown in FIG. 7. In this position, the square opening in the ring 110 is rotated clockwise by approximately 210 with respect to the square receptacle 112 so that the four straight sides of the opening in the ring extend over the four corners of the opening 112, as shown at 156, 158, 160 and 164 in FIG. 8. With the ring 110 in this position, and the projection 166 inserted into the receptacle 112, the projection 166 and the accessory are locked in position due to the fact that the edges 156, 158, 160 and 164 of the ring 110 extend into the groove 170 and prevent the accessory from coming free from the handle. The inner edge of the ring around the central hole is flat, as is the outermost wall of the groove 170 (FIG. 12) so that the arrangement of the two flat surfaces, perpendicular to the longitudinal axis of the projection holds the components together.

In addition, the square shape of the projection 166 and the corresponding square shape of the receptacle 112 prevent the accessory from rotating about its longitudinal axis relative to the handle.

The width and depth of the receptacle 112 and the width and length of the projection 166 are large enough to enable the attachment to withstand forces tending to bend the assembled tool during use.

It is highly advantageous that the locking of the accessory in place is performed very simply. As it is illustrated in FIG. 13, one merely inserts the projection 166 into the receptacle 112. The rounded front surface 168 FIG. 12) of the projection bears against the edge portions of the hole in the center of the ring 110 so as to compress the spring 126 and rotate the ring 110 counterclockwise to the position shown in FIG. 9 in which the square hole in the ring 110 is aligned with the receptacle 112 to permit the projection to be inserted into the receptacle. The resilience of the spring 126 causes the edges of the hole in the ring 110 to snap into the groove 170 at four different circumferentially spaced-apart locations. Thus, the edges of the hole serve as a latch element, and the groove 170 serves as a receiver or keeper for the latch element.

The release of an accessory from the handle is also is relatively easy. All that need be done is to press on the upstanding projection 124 on the ring 110 in the direction of arrow 162 (FIG. 7) to compress the spring 126 and rotate the ring 110 to the position shown in FIG. 9, thus releasing the accessory. As a result, with the simple one finger motion, the user may release the accessory and it will drop away from the handle if the handle is turned slightly upwardly to take advantage of the force of gravity. The release thus can be accomplished with one hand.

### Cheese Slicer

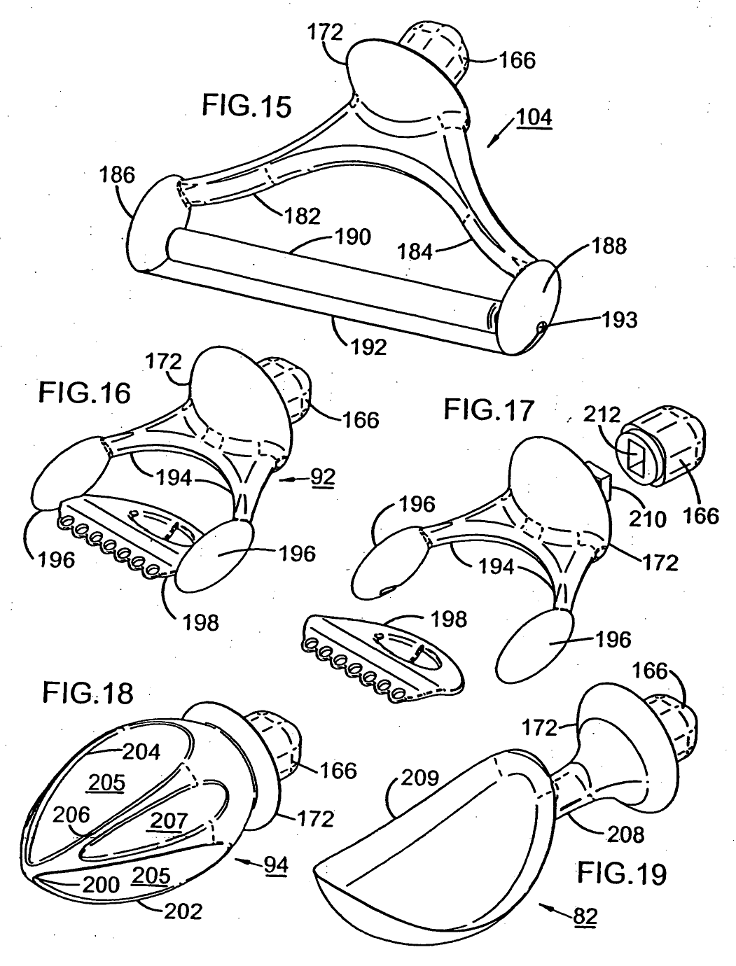

FIG. 15 shows the cheese slicer 104, which also is shown in FIG. 1. The cheese slicer has a die-cast zinc body. The projection 166 and the flange 172 are die cast with the body. The body has a pair of support arms 182 and 184 and mounting supports 186 and 188. A stainless steel cutting wire 192 is secured to the supports 186 and 188 by stainless steel pins 193. The wire extends over the front edges of the supports and is stretched taut to form a stable cutting element. A plastic roller 190 is rotatably mounted in the supports 186 and 188 at a pre-determined distance from the wire. The combination of the cutting wire 192 and the roller 190 are used in a known manner to cut cheese slices of a relatively constant thickness. The attachment structure has the strength and durability to stand up to the sometimes heavy pressure extended on the slicer during use.

In a lower cost version, the body can be molded polycarbonate instead of die-cast zinc.

### Zester

The zester 92 includes a mounting projection 166 and flange 177 with a pair of arms 194 and end supports 196. A stainless steel scraper element pivotably mounted on the supports 196. Preferably, the body, including the projection 166, is molded of polycarbonate material.

Although a single molding step is preferred, the projection or “insert” 166 also can be made separately and attached as shown in FIG. 17, to a square post 210 which is provided at one end of the accessory. The post is force-fitted into a square hole 112 in the insert 166 to secure it to the body of the accessory. This method can be used advantageously when the insert 166 and the body are made of different materials.

### Citrus Reamer

FIG. 18 shows the citrus reamer 94. It has a die-cast zinc body with a polycarbonate insert 166. The reamer has a rounded body with ridges 202, 204 and 206, and a pointed end 200.

Preferably, the reamer is formed with a longitudinally-extending axial hole, and the insert is co-molded to fill the hole to form a solid connection of the insert to the body.

The reamer is used to extract juice from lemons, limes, oranges and other such fruit, in a well-known manner.

### Ice Cream Scoop

FIG. 19 shows the ice cream scoop 82. It is die-cast zinc and consists of the projection 166, flange 172, a support arm 208, and a bowl-shaped scoop portion 209.

### Horizontal Peeler

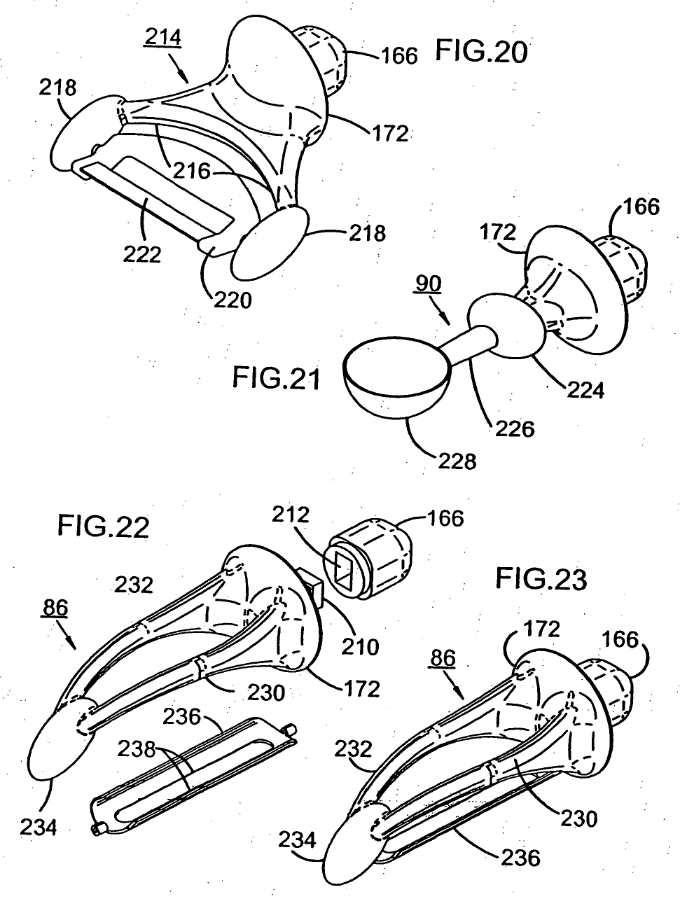

FIG. 20 shows what is called a “horizontal” peeler It is given this name in order to distinguish it from the so-called “straight” peeler shown in FIGS. 22 and 23 The peeler 214 includes a projection 166 and flange 172 forming part of a die-cast zinc body which has arms 216 and mounting supports 218 for rotatably supporting a blade mounting structure 220 with a cutting blade 222. The blade 222 is used in a known manner to peel vegetables, etc.

Alternatively, in a lower cost version, the body is made of molded polycarbonate.

### Melon Baller

FIG. 21 shows the melon baller 90, which has a molded polycarbonate projection 166 and flange 172, joined with a stainless steel stem 226 and cutting bowl 228 which is used to cut a melon ball in a known manner.

The enlarged section 224 is a joint which is formed to join the stainless steel elements to the plastic elements. The end of each segment is enlarged to increase the surface area of contact between the parts, projections are provided from the metal surface, and the plastic is molded to the metal.

### Straight Peeler

FIGS. 22 and 23 show the straight peeler 86. It consists of a metal or polycarbonate body including the flange 172 and the projection 166, and a body with spaced-apart support arms 232 with a support member 234 secured to the outer ends of the arms 230 and 232. A stainless steel cutting blade 236 with a pair of opposed, spaced-apart cutting edges 238 is rotatably mounted in the flange 172 and the support 234.

The assembled peeler shown in FIG. 23 is used in a known manner to peel vegetables, etc.

Although a single molding or casting is preferred, the insert 166 can be secured by the post 210 in the hole 212, as shown in FIG. 22.

### Grater

FIG. 44 is a perspective view of the grater 106. The grater 106 includes a stainless steel grater blade 378 with grater teeth 380, and a molded polycarbonate frame 374, projection 166 and flange 172. The frame is solidly secured to the edges of the blade 368 by forming the edges of the blade into numerous bent tabs at many locations on the edges, and co-molding the polycarbonate material over the edges.

The flange 172 and projection 166 form a substantial angle to the blade 378. The angle is provided in order to allow the grater to be held easily at the most desirable angle for most grating jobs, when the unit 106 is attached to the handle 88.

The rear surface of the border at the lower or outer end 379 of the grater is given a co-molded coating of elastomeric material to inhibit the grater from slipping when its rear lower edge is resting on a countertop, cutting board or other such support surface.

### Further Accessories

FIGS. 33 through 39 show some of the many additional accessories which can be used with the handle 88, or, with suitable modifications, with any of the other handle and attachment structures shown.

FIG. 33 shows a fork 320; FIG. 34 shows a medium-sized carving knife 322; FIG. 35 shows a bread knife 324; FIG. 36 shows a spoon 326; FIG. 37 shows a turner 328 such as a pancake turner; FIG. 38 shows a paring knife 330; and FIG. 39 shows an apple corer 332.

Preferably, the utensils are made of stainless steel and the flange 172 and projection 166 are made of polycarbonate co-molded over one end of the shaft of the utensil, such as the end 321 of the fork 320 shown in FIG. 33. Holes 323 in the end of the shaft are penetrated and filled with plastic during molding so as to solidly secure the plastic parts to the metal parts.

Each of these additional accessories has the square projection 166 with the groove 170 and the flange 172 so that they can be fastened to and used with the handle 88 shown above.

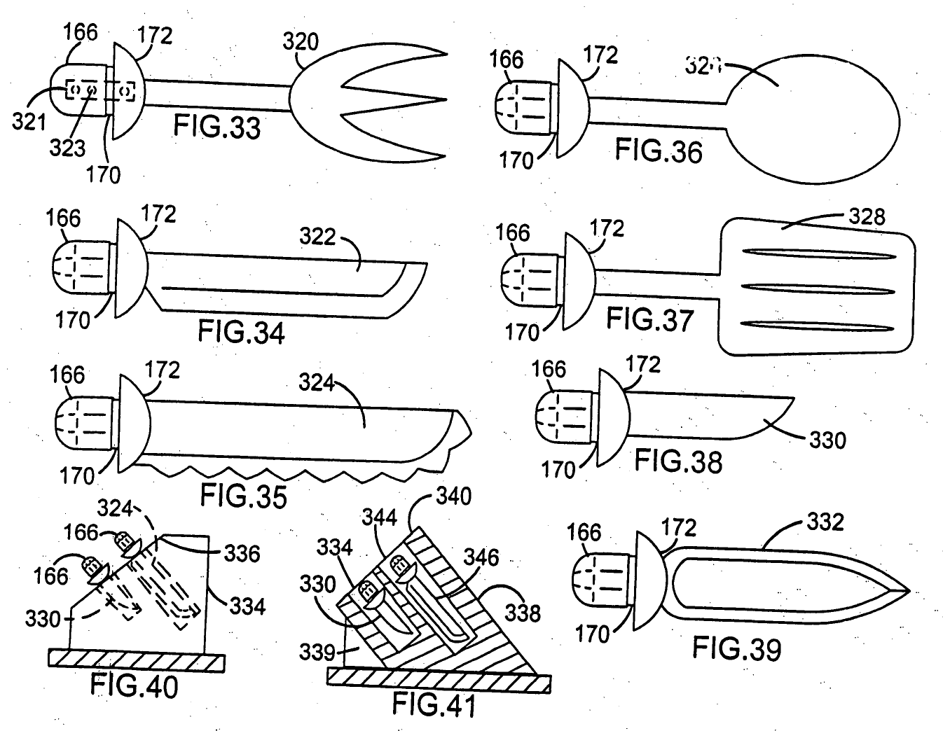

FIG. 40 shows a butcher block type of support 334 with a sloping face 336 and slots or holes cut into the face 336 to receive various different sizes of knives 324 and 330. This also comprises another version of the kit of the present invention. Advantageously, the projections 166 extend outwardly from the surface 336 so that a handle easily can be pushed downwardly on one of the projections 166 to secure the handle and the accessory together.

The mounting 334 can be made of wood, or transparent plastic to allow the utensils to be seen, and can have different shaped holes to receive other accessories so that they can be stored outside of the drawers in the kitchen.

FIG. 41 is shows another kit, similar to the one shown in FIG. 40. A block of wood 338 has circular holes, such as holes 344 and 342, of a depth greater than the combined length of the flange 172 and the projection 166 of each accessory, and slots or other shaped receptacles to receive kitchen utensils such as the paring knife 330 and a butcher knife 346. A further wooden block 339 supports the block 338 which leans at an angle so as to present the upper surface 340 of the block at an angle.

The openings 342 and 344 preferably are made considerably larger in diameter than the diameter of the flange 172, in order to easily receive the attachment end of one of the handles 88 so that the handle can be inserted into the cavity to attach to each of the tools stored in the block 338.

By this means, the attachment ends of the knives 330 and 346 are recessed out of view.

If desired, the block 338 in FIG. 40 can be made transparent, or windows can be provided to allow the utensils within to be seen. Alternatively, or in addition, a marking next to each opening can be provided to identify its contents.

The variety of utensils which can be used to advantage in the multi-tool system is extensive. In addition to those shown, such utensils include can openers, jar openers, bottle/can openers, garlic presses, whisks, ladles, serving spoons with tines for handling spaghetti, strainer spoons and ladles, pie servers, spatulas, potato mashers, meat tenderizers, strainers, pots and pans, or many other utensils which have handles.

Each of the multi-tool system components is made dishwasher-safe; that is, the component can be washed regularly in a dishwasher without significant deterioration. The cracking and deterioration of wooden and some prior plastic handles has been avoided, at a cost that is considerably reduced because there are many more accessories than handles.

### Alternative Attachment Structure

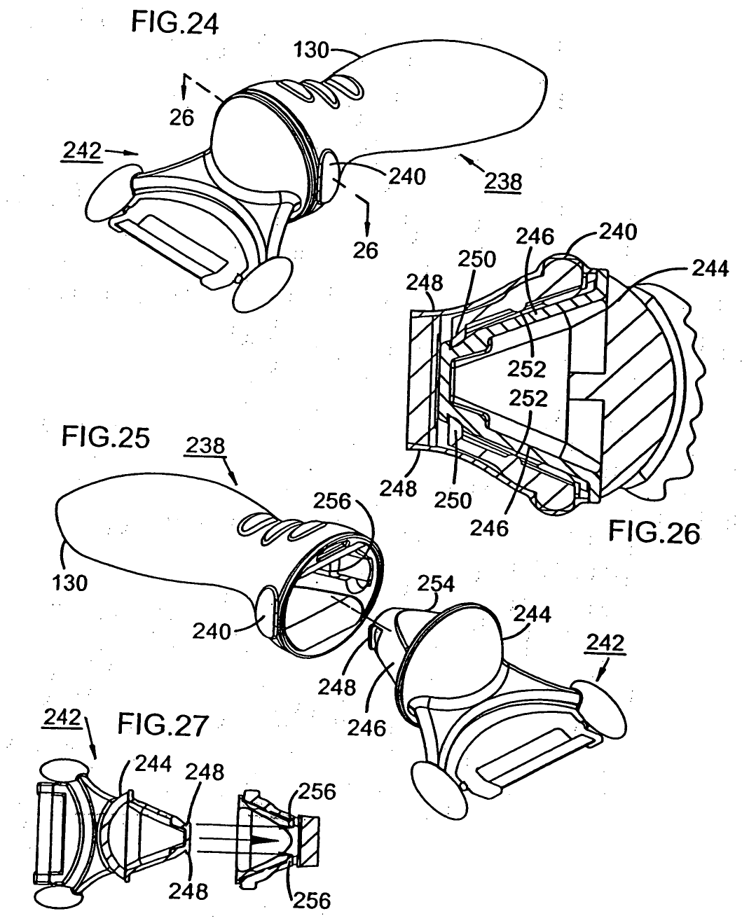

FIGS. 24 through 27 illustrate an alternative attachment structure for attaching accessories to the handle in the multi-tool system. The assembled device shown in FIG. 24 includes a handle 238 with an attached horizontal peeler 242, whose construction is substantially the same as the horizontal peeler 214 shown in FIG. 20, except for the means used for attaching it to the handle.

Referring now to FIG. 26, which is a cross-sectional view taken along line 26-26 of FIG. 24, the attachment means includes a rounded flange 244 to which a projection structure is attached and extends to the left as shown in FIG. 26. The projection structure includes side walls 246 and a pair of opposed projections 248 forming catch receivers.

A pair of release push-buttons 240 is mounted on opposite sides of the handle (see FIGS. 24 and 25). Each of the push buttons actually is the end of a molded lever mechanism which has a pivot point 52 and catch arms 256.

When the projection of the accessory is pushed into the receptacle shown in FIG. 25, the forward edges of the projections 248 push the flexible plastic catch arms 250 aside, and those arms snap back into the notches or receivers formed by the projections 248, thus providing a snap-action catch which locks the accessory to the handle.

In order to release the accessory from the handle, the buttons 240 are pushed with the fingers. This rocks each of the arms 250 around the pivot points 252 and pulls them away from engagement with the projections 248, thus releasing the accessory from the handle.

As it is shown in FIG. 25, a further projection 254 shaped to mate with a receiving hole 256 in the handle is provided on the accessory in order to further guide the accessory accurately into the handle cavity.

A handle as in Claim 9 OM which said cover has a hardness of approximately 50±2 Share A.

### Second Alternative Attachment Structure

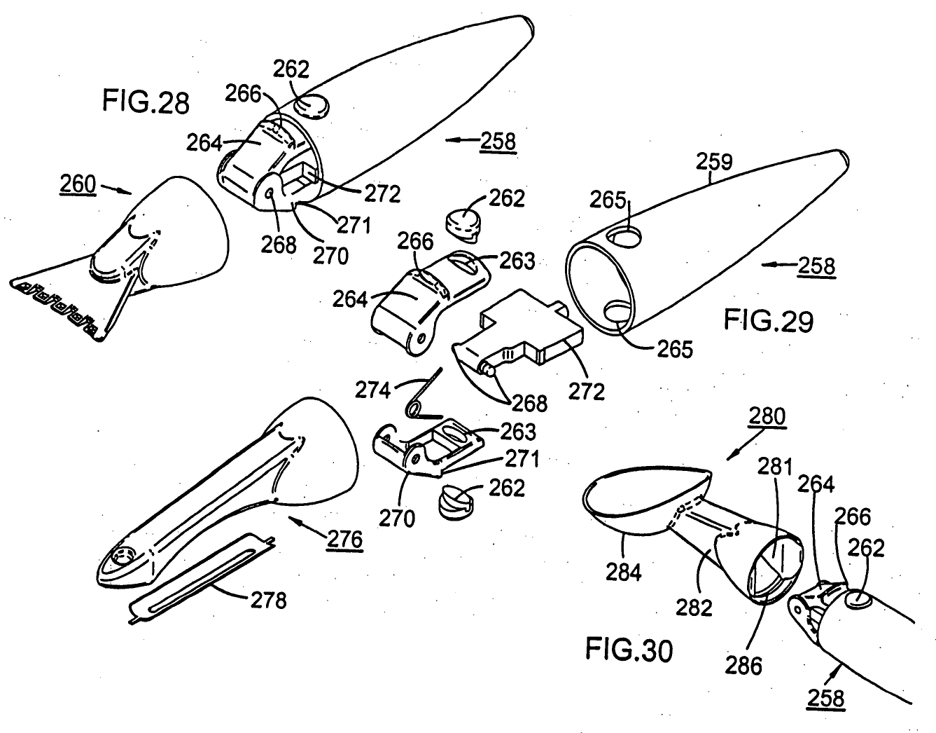

FIGS. 28 through 30 show a second alternative attachment structure.

The structure shown in FIGS. 28 through 30 includes a handle 258 and three different accessories 260, 277 and 280 for attachment to the handle. The accessory 260 is a zester, the accessory 276 is a straight peeler with a blade 278, and the accessory 280 is an ice cream scoop.

The attachment structure includes a pair of inclined latch members 264 and 270 with catch surfaces 266 and 271 respectively. Both elements 264 and 270 are pivotably mounted on pins 268 on a mounting member 272 which is secured within the housing 259 of the handle 258.

A spring 274 also is mounted to rotate on the pin 268, and serves to thrust the two members 264 and 270 apart.

Two release buttons 262 are mounted in holes 265 in the housing of the handle and holes 263 in the members 264 and 270. By depression of the release buttons 262, the elements 264 and 270 are pivoted inwardly towards the center of the handle to withdraw each of the catch edges 266 and 271 from a corresponding receiver in the accessory.

Referring to FIG. 30, one such receiver edge is shown at 286. Another (not shown) is located at the upper part of the opening in the accessory 280. The accessory 280 includes a support arm 282 and an ice cream scoop bowl 284.

The body of the accessory has a tapered inlet opening 281 which receives the tapered projection formed by the elements 264, 270 and 272, and the straight sides of the elements 264 and 270 mating with the straight sides of the opening 28 keep the accessory from rotating on the handle.

### Third Alternative Attachment Structure

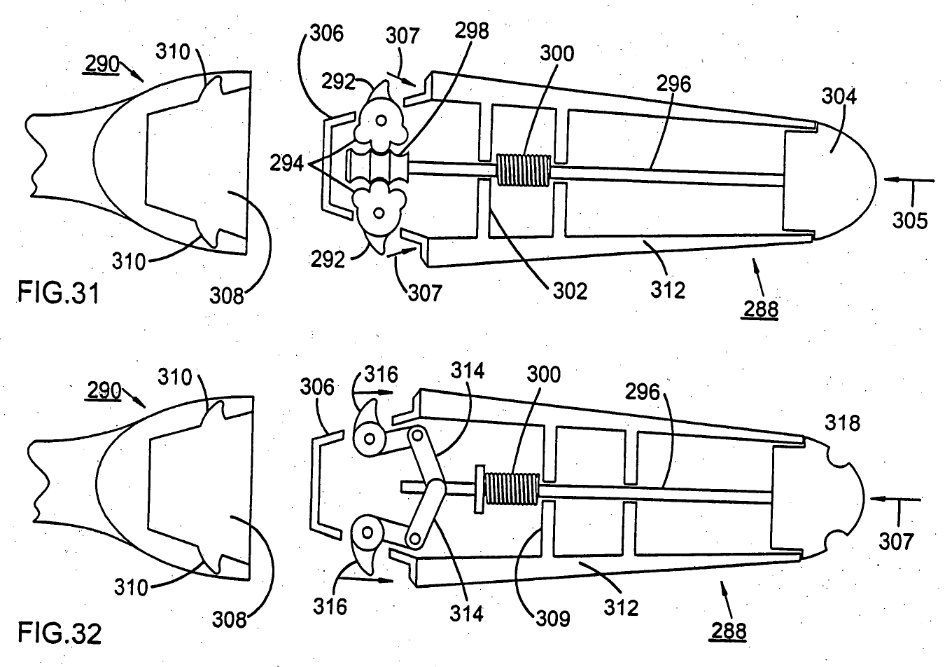

FIG. 31 is a schematic diagram of another attachment device of the invention. The structure shown in FIG. 31 includes a handle 288 having a housing 312 with a longitudinal shaft 296, and a coil spring 30 surrounding the shaft 296 and bearing against a bulkhead 302 through which the shaft 296 passes.

The shaft 296 has a rack structure 298 at its left end which mates with gear teeth 294 on catch members 292 rotatably mounted in the housing 312. It should be understood that the rack is not shown engaged with the gear teeth, for the sake of clarity in the drawings. However, it should be understood that they are so engaged.

The accessory 290 has a tapered cavity 308 with opposed receivers 310 for the catch members 292. The forward end of the handle is tapered as shown at 306.

In operation, the spring 300 tends to hold the projections 292 in their fully extended position, as shown in FIG. 31, so as to keep the members 292 engaged in the receivers 310 to hold the accessory onto the handle.

When it is desired to release the accessory from the handle, an externally-extending end attachment 304 to the shaft 296 is pushed inwardly in the direction indicated by arrow 305. This rotates the members 292 about their pivots and withdraws them from the receiving notches 310 so as to release the accessory from the handle.

When the tapered end 306 of the handle is inserted into the tapered cavity 308 in order to attach the accessory to the handle, the sloping side walls of the cavity 308 rotate the elements 292 backwardly until they move far enough to snap into the receiving notches 310.

### Fourth Alternative Attachment Structure

FIG. 32 shows a fourth alternative attachment structure, which is the same as that shown in FIG. 31 except that the coil spring 300 bears against a bulkhead 309, and the pivotably mounted catch members 316 are rotated by means of a linkage instead of a rack and pinion arrangement such as that shown in FIG. 31.

The linkage includes a first link 314 pivotably attached at one end to the shaft 296, and pivotably connected at its other end to one end of the lever arm forming part of the catch member 316.

When it is desired to release the accessory from the handle, an end extension 318 on shaft 296 is pulled in the direction indicated by arrow 307 to compress the spring 300 and withdraw the catch elements 316 from the receiving notches 310 in the accessory 290.

When the tapered forward end 306 of the handle is inserted into the tapered cavity 308 of the accessory 290, the side walls of the cavity cam the catch members 316 in the direction shown by the arrows and then, when they reach the receiving cavities 310, they snap into place under the urging of the spring 300.

It can be seen from the foregoing that in all of the attachment embodiments, it is possible to engage an accessory with the handle simply by pushing the two together. The accessory snaps into place without requirement of the operation of a lever or the like.

Also, releasing the accessory from the handle involves no more than button pushing, and can be done with one hand while allowing gravity to remove the accessory from the handle.

### Counter-Top Display Kit

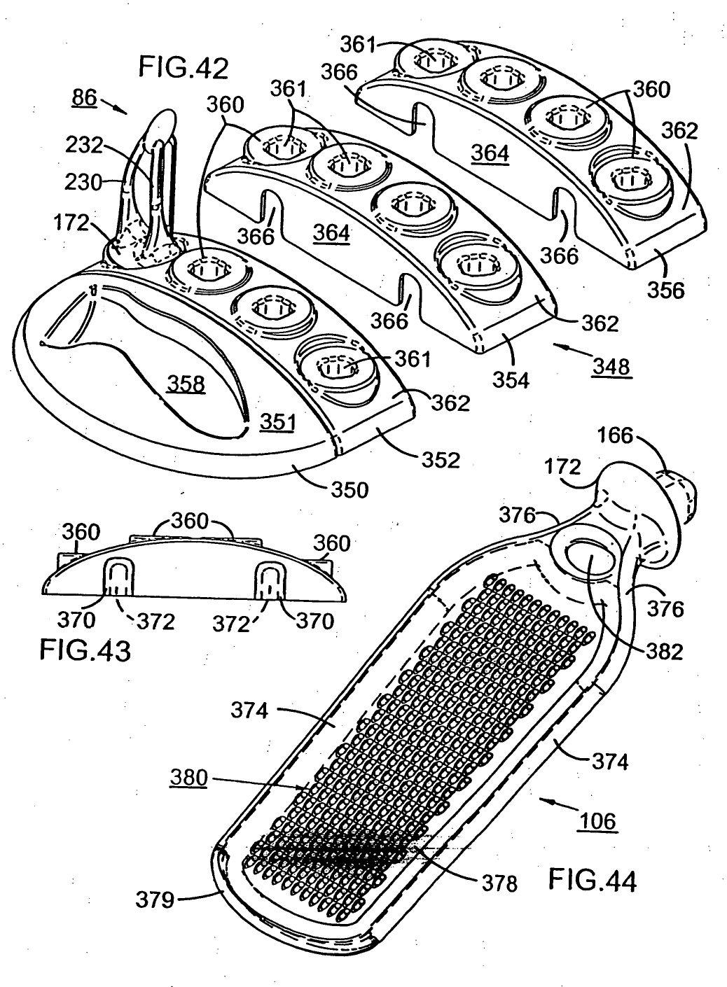

FIG. 42 is a perspective view of another kit constructed in accordance with the invention. The kit allows the storage, organization and display of the handle 88 and accessories on a cupboard shelf or counter-top, or a counter-top or shelf in a store selling the product, etc.

The kit 348 includes a handle mounting and storage unit 350 with a curved and sloping top wall 351 and a recess 358 shaped to receive and hold the handle 88 where it can be easily seen, grasped and replaced.

Also included are modular storage and display units 352, 354, 356, etc., for holding and displaying accessories for use with the handle 88.

Each of the units 352, 354 and 356 is identical to the other. Each has four upstanding projections or bosses 360 each of which has a flat, horizontal upper surface with a central square hole 361 slightly larger than the projections 166 on the attachments so that the attachments can be stored upright with the attachment projections 166 extending into the holes 361.

One such attachment, a straight peeler 86, is shown mounted in one of the holes in the unit 352. As it can be seen, the flange portion 172 of the peeler rests on the upper surface of the boss 360 and the working portion of the peeler 86 extends upwardly where it can be seen, grasped and replaced easily.

Each of the three units 352 and 354 has an upper arcuate surface 362 from which the bosses 360 extend. Each unit also has a front side wall 364 and a rear side wall 368 shown in FIG. 43.

Each front side wall 364 has a pair of vertical notches or gaps 366, and the rear wall 368 has a pair of upstanding tabs 370 spaced apart by the same distance as the notches or gaps 366. The width of each of the tabs 370 is greater than the width of each of the gaps 366. The tabs 370 are molded with a vertical member 372 attaching it to the rear wall 368.

The tabs 370 can be fitted into the gaps 366 to tightly secure each of the units 352, 354 and 356 together.

The handle storage and display unit 350 also has a rear structure such as that shown in FIG. 43 whereby one of the units 352, 354 and 356 can be attached to the rear of the unit 350.

Thus, for a person wishing to start with only a few accessories, he or she can buy a kit including, for example, only the units 350 and 352 which provides a handle and four accessories.

Later, if the person decides he or she wants to add to the original multi-tool system, one or more additional units 354 or 356 can be purchased with one to four additional accessories and attached to the other units to form a readily expandable multi-tool system.

The units 350, 352, 354 and 356 preferably are molded of thermoplastic material such as ABS.

The counter-top units shown in FIGS. 42 and 43 also serve well to display the multi-tool system on store counters and shelves, and in television and other advertising. Thus, the units serve double-duty; saving space and adding convenience in the kitchen, while serving to show the product in a good light.

The above description of the invention is intended to be illustrative and not limiting. Various changes or modifications in the embodiments described may occur to those skilled in the art. These can be made without departing from the spirit or scope of the invention.

What is claimed is:

1. A kitchen implement handle comprising, in combination,
an inner core of relatively hard material and a cover of relatively soft and resilient material,
said handle having a forward end where said implement is attached, and a trailing end,
said handle having a first portion of relatively small diameter near said forward end, and a second portion of relatively larger diameter between said trailing end and first portion,
said second portion of said handle extending at an angle to said first portion of said handle.

2. A handle as in claim 1 in which said cover is made of silicone rubber.

3. A handle as in claim 1 in which said handle includes a hard core, a silicone rubber cover, and a fluid silicone gel layer between said hard core and said cover, said combination of cover and gel layer acting together to allow said cover and said gel layer to conform to the shape of the hand of a user when gripping the handle.

4. A handle as in claim 3 in which said silicone gel has a molecular weight of between approximately 10,000 and 30,000.

5. A handle as in claim 4 in which said cover has a hardness of approximately 50 Shore A, and said cover is approximately twice as thick as said gel layer.

6. A kitchen implement with a handle secured to the kitchen implement, said handle having
a hard central core,
an outer cover of silicone rubber, and
a fluid silicone gel layer between said core and said cover,
said gel having a molecular weight of from about 10,000 to about 30,000.

7. A kitchen implement as in claim 6 in which said cover has a hardness of approximately 50 Shore A.

8. A kitchen implement as in claim 6 in which said core and said cover both have a forward end and a trailing end, in which said cover is securely attached to said core at said ends, and said gel fills the space between said cover and said core between said ends, said cover being about twice as thick as said gel layer.

9. A kitchen utensil handle comprising:
a. a relatively inflexible elongated core member having a central portion and two opposed end portions;
b. an outer cover made of silicone rubber and being softer than said core member;
c. said cover extending around and covering said core member and being spaced from said central portion of said core member and being secured to said core member at said ends, and
d. layer of silicone gel in the space between said cover and said central portion of said core member.

10. A handle as in claim 9 in which said core member has an attachment structure at one of said end portions for attaching said handle to a kitchen utensil structure.

11. A handle as in claim 9 in which said core member and said cover have a wasp shape.

12. A handle as in claim 9 in which said core member and said cover have a section of reduced cross-section adjacent to one of said end portions, said core member and cover being bent to form an acute angle with said core end position.

13. A handle as in claim 9 in which said core member has at one of said end portions a plurality of projections extending outwardly therefrom and making contact with said cover to hold said cover in position on said core member.

14. A handle as in claim 9 in which said core member has a longitudinal axis, and, located at one of said end portions, an axially-extending hole, said cover having at one end a projection extending into said hole.

15. A handle as in claim 15 in which said hole is a slot which has side-walls with barbs extending into said hole to grip and hold said projection, said projection being flat with a substantial transverse body area.

16. A handle as in claim 13 in which said core member has, at said one end, a circumferentially-extending recess with a bottom and projections extending radially outwardly from said bottom of said recess.

17. A handle as in claim 13 in which said core has an attachment structure at said one end for attaching said handle to a kitchen utensil structure.

18. A handle as in claim 9 in which said gel has a molecular weight of about 10,000 to 30,000

19. A handle as in claim 13 in which said core member has a circumferential recess spaced from but adjacent said projections.

20. A handle as in claim 9 in which said cover has a hardness of approximately 50±2 Share A.
